(19) United States
(12) Patent Application Publication
(10) Pub. No.: US 2017/0236095 A1
(43) Pub. Date: Aug. 17, 2017

(54) SYSTEM AND METHOD FOR GENERATING A CAREER PATH

(71) Applicant: WORKEY EMPLOYEES RECRUITMENTS LTD, Tel Aviv (IL)

(72) Inventors: Amichai SCHREIBER, Modiin (IL); Ben REUVENI, Caesarea (IL); Danny SHTAINBERG, Tel Aviv (IL); Roy REUVENI, Caesarea (IL)

(73) Assignee: WORKEY EMPLOYEES RECRUITMENTS LTD

(21) Appl. No.: 15/208,649

(22) Filed: Jul. 13, 2016

Related U.S. Application Data
(60) Provisional application No. 62/293,811, filed on Feb. 11, 2016.

(51) Int. Cl. G06Q 10/10; G06F 3/0482; G06F 17/30

(52) U.S. Cl. CPC G06Q 10/1053; G06F 17/30327; G06F 3/0482

(57) ABSTRACT

A system and method for determining a career path, comprising: providing user interface displayed on a user's computerized apparatus; receiving a current job title from the user; associating a source profession, a management level and an experience level to said job title; obtaining a target profession associated with a target management level and a target experience level; determining at least one career path comprising one or more transition professions required to reach the target profession from the source profession; calculating transition probability scores associated with said transitions; generating, in real time, a display indicating the career path; and displaying on a display unit, a career path including at least the source profession and the target profession and the associated transition probability score per transition.

### FIELD OF THE INVENTION

The present disclosure generally relates to providing a user with a personalized career path, e.g. based on the user's career history and/or on acquired career data.

### BACKGROUND

Employees generally wish to advance their career, since progress or promotion in the work place typically means higher appreciation, and improved benefits. However, it is not always easy to be promoted at the organization a person is already working at. Furthermore, it may be complicated to find the right position, which will offer an improvement in terms of success, appreciation, satisfaction, and increased salary or other benefits.

A career path generally refers to the growth of an employee in an organization or between organizations. It refers to various positions an employee fills or transitions to as the employee grows, e.g., in an organization or across multiple organizations. An employee may transition positions vertically (e.g., progress in the seniority of the position or the management level), or laterally (e.g., work in a different department in the same or similar position), or cross functionally, e.g., move to a different type of job role.

### SUMMARY

Providing a user with a career path that is tailored to his/her professional preferences and goals, based on his past professions/positions, which may provide that user the knowledge of what would be his next best career move in order to reach a professional goal, will save time, effort and even money for any person who wishes to develop his career with a feasible or high probability, and/or within the shortest time period.

One exemplary embodiment of the disclosed subject matter is a method for determining a career path comprising at least a portion of the following steps:
providing user interface displayed on a user's computerized apparatus;
receiving a current job title from the user;
associating a source profession, a management level and an experience level to said job title;
obtaining a target profession associated with a target management level and a target experience level;
determining at least one career path comprising one or more transition professions required to reach the target profession from the source profession, wherein each transition profession is a profession that enables the user to progress towards the target profession;
calculating transition probability scores associated with a transition of the user from the source profession to a transition profession of the one or more transition professions, or from a transition profession to a transition profession, or from a transition profession to the target profession, based on statistical career data;
determining feasibility of each transition; and
causing the user interface to display on a display unit, in real-time, a career path including at least the source profession and the target profession and the associated transition probability score per transition.

According to some embodiments, calculating probability of transition is based on a statistical database storing data of other persons who went through the same transition.

In some embodiments, the method may further comprise classifying the transition as either a professional transition, a promotion or a change in profession. In some embodiments, classifying the transition may comprise displaying several job positions to a user, receiving user input regarding preferences per each displayed job position, wherein each job position is previously classified as a professional transition, promotion or a change in profession, determining a user's transition classification preference based on the user's input, and suggesting new job positions to the user based on the user's transition classification preference.

In some embodiments, associating a source profession to the job title is based on a profession database.

According to some embodiments, determining feasibility of the transition comprises comparing the transition probability score to a feasibility threshold.

In some embodiments, the method may further comprise defining a feature vector that includes values of parameters associated with statistical changes in profession, management level and in experience level; and training a classifier to identify probable profession transitions.

In some embodiments, the method may further comprise determining a plurality of optional career paths, and displaying the career paths with their associated transition probability scores.

Another exemplary embodiment of the disclosed subject matter is a system for determining a career path, comprising a processing unit configured to perform at least a portion of the following functions:
provide user interface displayed on a user's computerized apparatus;
receive a current job title from the user;
associate a source profession, a management level and an experience level to said job title;
obtain a target profession associated with a target management level and a target experience level;
determine at least one career path comprising one or more transition professions required to reach the target profession from the source profession, wherein each transition profession is a profession that enables the user to progress towards the target profession;
calculate transition probability scores associated with a transition of the user from the source profession to a transition profession of the one or more transition professions, or from a transition profession to a transition profession, or from a transition profession to the target profession, based on statistical career data;
determine feasibility of each transition; and
generate, in real time, a display indicating the career path from the source profession to the target profession; and
   a display unit to provide the display indicating a career path including at least the source profession and the target profession and the associated transition probability score per transition.

In some embodiments, the display of the career path may be provided to the user in a visual and/or auditory manner. In some embodiments, career path may be displayed using a hierarchical tree structure, though other graphical and/or audio displays may be implemented.

### BRIEF DESCRIPTION OF THE DRAWINGS

Some non-limiting exemplary embodiments or features of the disclosed subject matter are illustrated in the following drawings.

Identical or duplicate or equivalent or similar structures, elements, or parts that appear in one or more drawings are generally labeled with the same reference numeral, and may not be repeatedly labeled and/or described.

Dimensions of components and features shown in the figures are chosen for convenience or clarity of presentation and are not necessarily shown to scale or true perspective. For convenience or clarity, some elements or structures are not shown or shown only partially and/or with different perspective or from different point of views.

References to previously presented elements are implied without necessarily further citing the drawing or description in which they appear.

FIG. 1 is a schematic diagram of a system for providing a career path, according to exemplary embodiments of the disclosed subject matter;

FIG. 2 is a flowchart of a method for performing profession classification, according to exemplary embodiments of the disclosed subject matter;

FIG. 3 is a flowchart of a method for correlating between skills and professions, according to exemplary embodiments of the disclosed subject matter;

FIG. 4 is a flowchart of a method for calculating probability of transition from one profession to another, according to exemplary embodiments of the disclosed subject matter;

FIG. 5 is a flowchart of a method for providing a career path to a user, according to exemplary embodiments of the disclosed subject matter;

FIG. 6 is a flowchart of a method for choosing a career path for a user, according to exemplary embodiments of the disclosed subject matter; and

FIGS. 7A-7G are schematic illustrations of displayed career paths including a target profession and several transition professions and source professions through which and from which, respectively, the target profession may be reached, according to exemplary embodiments of the disclosed subject matter.

### DETAILED DESCRIPTION

In the context of the present disclosure, without limiting, the term ‘job title’ relates to a title of a job or a work position, which is typically defined and provided by a user of a system for determining a career path as disclosed herein. For example, a job title may be: an attorney, a medical doctor, a dietitian, a salesperson, etc.

In the context of the present disclosure, without limiting, the term ‘profession’ relates to a combination of skills and occupation. One or more job titles may correspond to a single profession, since a profession is more general and describes a function or functions that the user is accomplishing, whereas a job title is defined by a matter of personal taste and phrasing, while not necessarily merely describing the function that the user is fulfilling. For example, a profession may be: a front end engineer, while the job titles that may correspond to this single profession may be any of the following: “front end engineer”, “front end developer”, “web programmer”, “UX engineer”, etc., since all of the listed job titles perform the same function as performed by the profession of “front end engineer”.

In the context of the present disclosure, without limiting, the term ‘management level’ relates to or correlates to the number or range of numbers of employees managed by or supervised by a person or user, whether directly or indirectly. The management level may also be related to an executive level. The management level may be associated with a certain job title, e.g. with a certain position or profession. A user may be associated with a management level value or score, e.g. the highest number of people that a user supervised during past or current positions. The management level may be associated with a user's present or past positions, or with target positions. A profession may also be associated with a management level value. In one example, a person or user who manages two employees, may be assigned with management level value of “2”, while a person or user who manages ten employees, may be assigned with management level value of “10”. In another example, a user who does not supervise employees may be assigned a management level value “0”, a user who supervises between two to four employees may be assigned a management level “1”, and a user who manages between five to ten employees may be assigned a management level value “2”, etc. Other combinations or formulas may be used to determine a management level value. The management level value may be a score or an indicator, e.g., an alphanumeric value, or a numeric value.

In the context of the present disclosure, without limiting, the term ‘experience level’ relates to or correlates to the number of years a person or user is employed under the same job title or under a certain profession, and/or related professions. The experience level value may be associated with a certain job title, or with more than one job titles, since one profession may include more than one job title. An experience level may be a score or an indicator, e.g., an alphanumeric value, or a numeric value.

In the context of the present disclosure, without limiting, the term ‘source profession’ relates to a profession that a person or user is currently practicing, or that a user wishes to start a career path from. For example, a source profession may be: account management, engineering, customer support, marketing, etc.

In the context of the present disclosure, without limiting, the term ‘target profession’ relates to a profession that a person or user wishes to reach from the source profession that the person or user is currently practicing. For example a target profession may be: “marketing”, “software architect”, “capital management”, etc.

In the context of the present disclosure, without limiting, the term ‘transition profession’ relates to a profession that may be reached from a source profession while progressing closer towards the target profession.

In the context of the present disclosure, without limiting, the term ‘career path’ relates to a path of professions beginning with a source profession towards reaching a target profession, which may include transition professions in between. A career path may illustrate the preferable route for a person currently holding a source profession to reach his target profession. The career path may also illustrate the fastest route for reaching the target profession from the source profession.

A career path, in the context of the present disclosure, refers to a source profession or a starting profession, any number of transition professions (e.g. zero or more), and a target profession. An employee may transition positions vertically (e.g. progress in the seniority or management level of a profession), or laterally (e.g. by moving to a different department or different company, in the same or similar position), or cross functionally, e.g. move to a different type of job role.

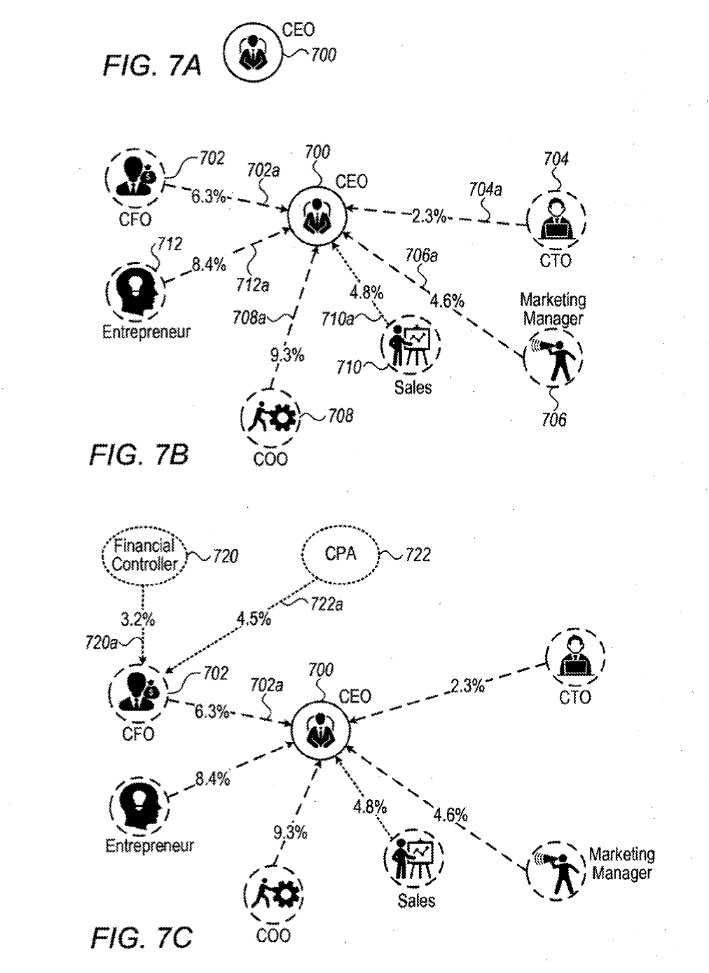

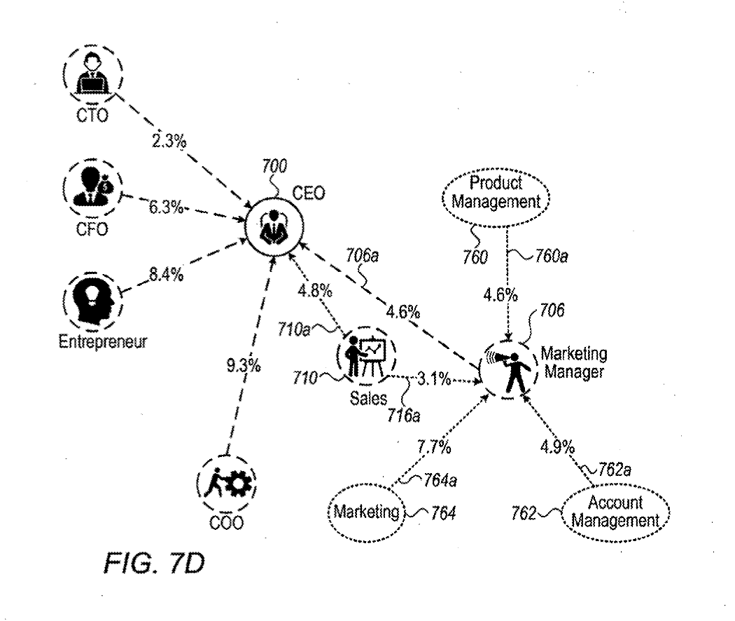

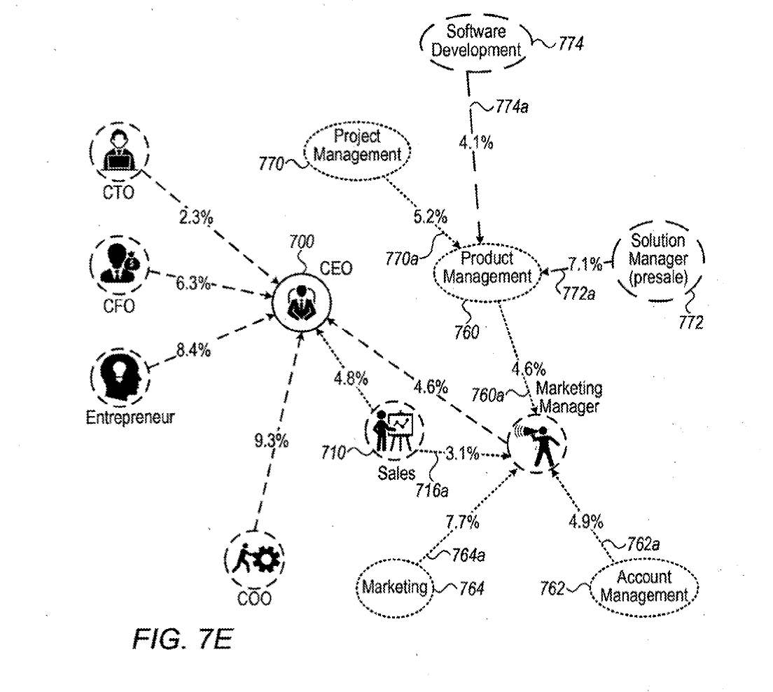

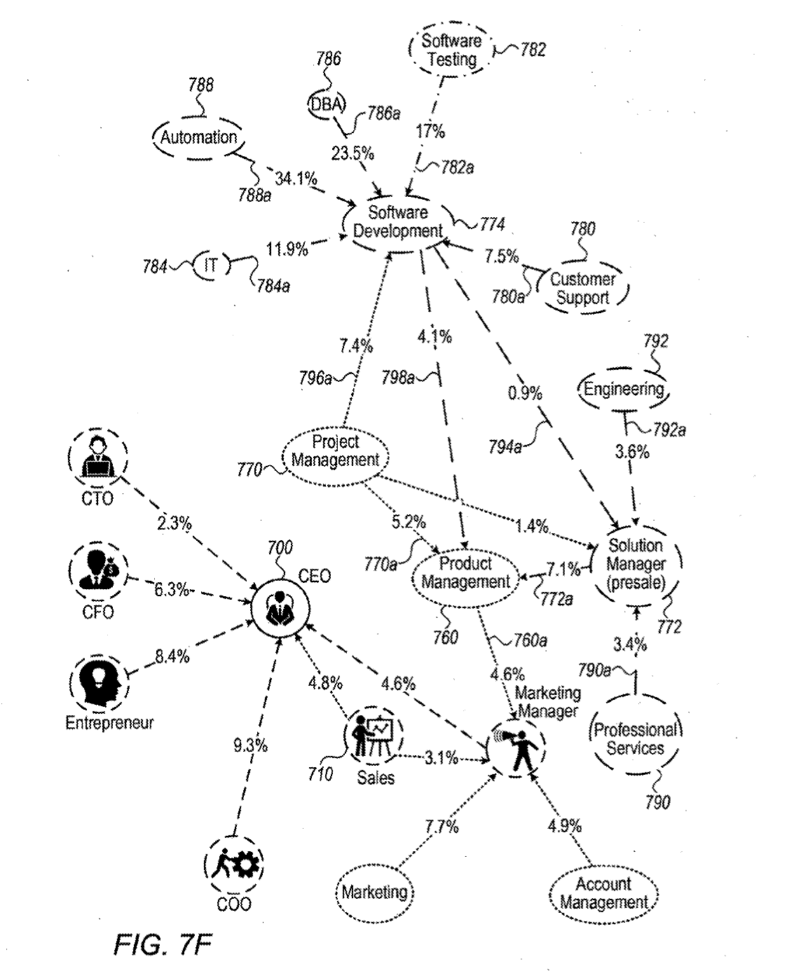

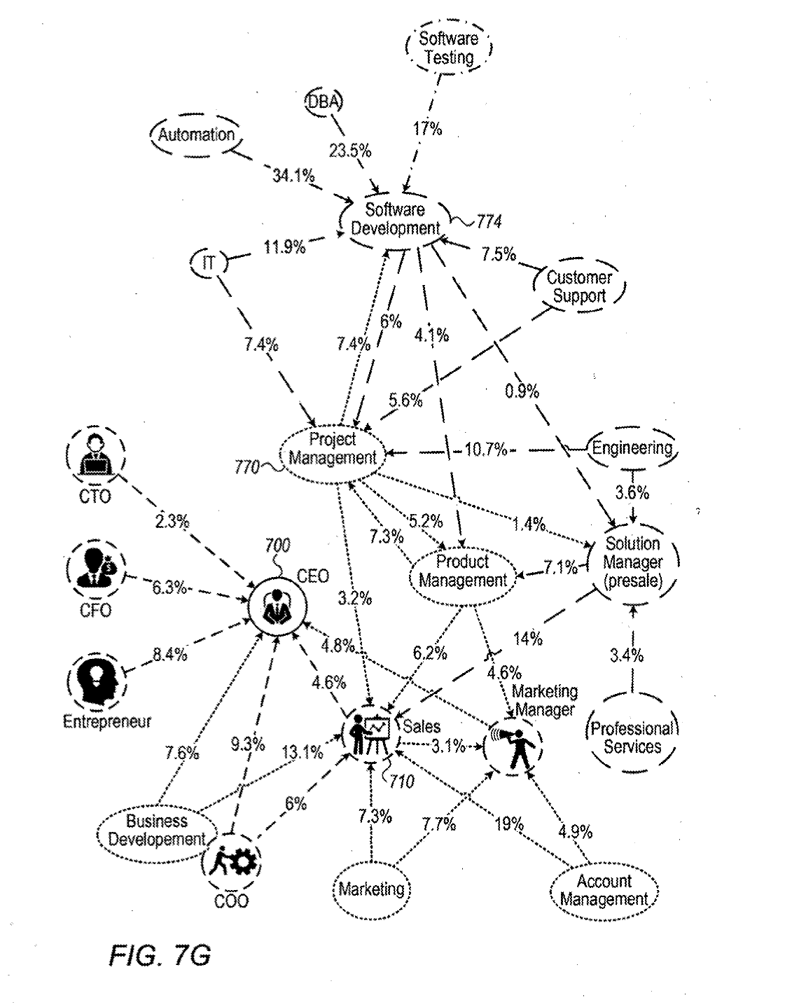

A length of a career path may be defined, in the context of the present disclosure, as the distance between the source profession and the target profession. In some embodiments, the distance may correspond to a number of transitions a person needs to make in order to reach a target profession from a source profession, via transition professions. For example, in some cases a person needs to make only one transition in order to reach a target profession from a source profession, e.g., if a user holds a position of a Chief Finance Officer (i.e., source profession), and his target profession is a Chief Executive Officer. In other cases, a person may need to make more than one transition in order to reach a target profession from a source profession, for example, if a user currently holds a position of an engineer, and his target profession is a marketing manager, then the user may need to make, for example, four transitions in order to reach the target profession (as illustrated in the example of FIG. 7F). In other embodiments, a length of a career path may be defined by the total expected duration of the path. The total expected duration of the path may be the sum of expected durations of each transition along the path. For example, for each transition from profession A to profession B, the expected duration is calculated by determining the mean time that people typically held position A before proceeding to work at position B. Thus, the sum of expected duration for each of the transitions included in a career path defines the length of the career path.

In some embodiments, the shortest career path may be determined by taking into consideration the number of transitions along the career path as well as the total expected duration of the career path. That is, a user may decide whether to follow a career path that includes the lowest number of transitions, or a career path whose total expected duration is the shortest.

In the context of the present disclosure, without limiting, the term ‘transition probability’ relates to probability or chances of a user of changing his position from one profession to another. A user may transition professions laterally, vertically, or cross-functionally, as explained hereinabove, and the probability of each of these transitions may be calculated, based on statistical career data, in order to determine whether any of the transitions is feasible.

The terms cited above denote also inflections and conjugates thereof.

The employment market is known for its instability, and there are many parameters to assert whether a certain position is satisfactory for a person. It is difficult to assess which positions are regarded highly by a certain person, e.g., are considered by the person as enabling to earn an income he is satisfied with, and feel fulfillment with what he does. Furthermore, it may be difficult to foresee what kind of career changes or transitions a person should follow in order to promote his career in the direction he wants, and in order for the person to advance in the employment market.

One target of the present disclosure is to provide a system and method for determining and displaying, in real-time, one or more options for a personalized career path that will illustrate for each specific person or user one or more suggested routes or career paths that the user may follow career-wise, in order to achieve his professional goals. By viewing the proposed career path(s), the user may have the ability to decide on his next career change in a logical and intelligent way, since the career paths are calculated and presented according to a probability or feasibility of making the professional transitions, based on a large database of real users, and statistical analysis thereof.

The present disclosure further provides a system and method, which, in real-time or substantially real-time, may provide information relating to a career transition that may bring the user closer to his professional goals, e.g. with a certain feasibility or probability level and/or within a certain time period or within the shortest possible time period.

A general non-limiting presentation of practicing embodiments of the present disclosure is given herein, outlining exemplary practice of embodiments of the present disclosure and providing a constructive basis for variant and/or alternative embodiments, some of which are subsequently described.

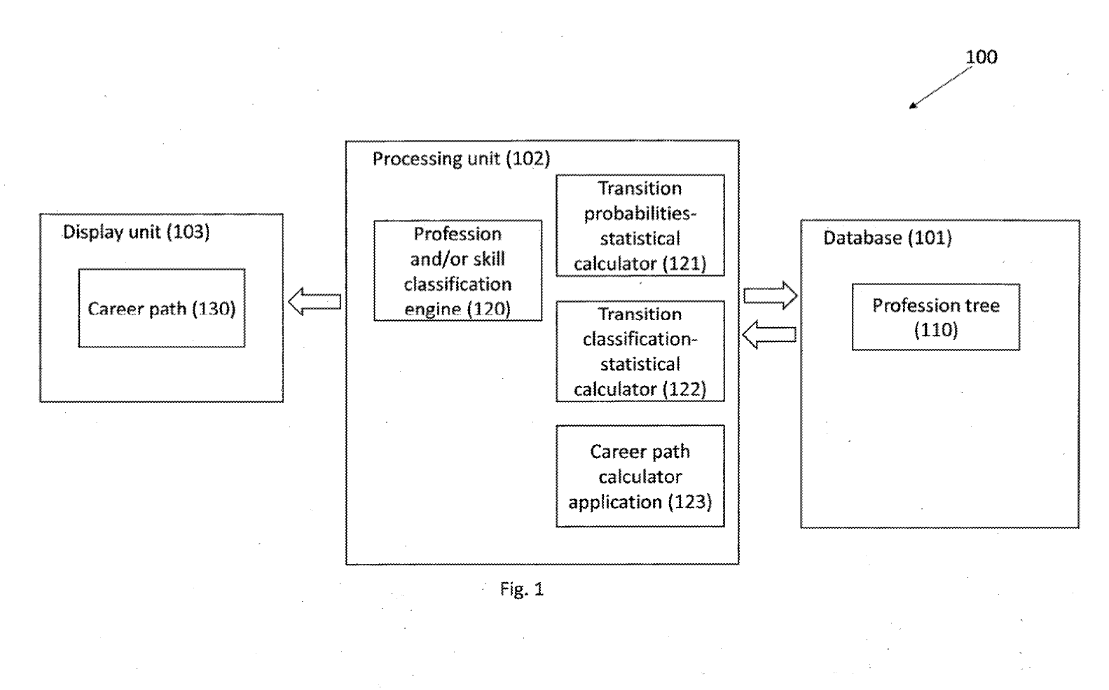

FIG. 1 is a schematic diagram of a system for providing a career path, according to exemplary embodiments of the disclosed subject matter. System 100 may comprise a database 101, processing unit 102, and display unit 103. In some embodiments, processing unit 102 may be configured to run or operate a career path calculator application 123, for determining and displaying a career path to a user, on the user's computerized device, or on a server, cloud or any other location of the sort.

Calculations and classifications performed by system 100, may be based on information stored in database 101. Database 101 may be or may include a data storage unit. Database 101 may be operationally connected to, or may include one or more data resources which may be accessible by system 100.

In some embodiments, database 101 may comprise profession tree 110. According to some embodiments, profession tree database 110 may comprise a list of professions and inter-connections or relationships between these professions. In some embodiments, the list of professions may be modeled using a data structure such as a tree (e.g., an abstract data type that simulates a hierarchical tree structure, with a root value and subtrees of children with a parent node, represented as a set of linked nodes). In such tree, profession X is a descendant of profession Y if and only if profession X is a specific type of profession Y. For example, “Legal Consultant”, “Patent Agent” and “Partner [in a Law Firm]” are all descendants of the “Legal” generic profession or umbrella profession. It is possible to continue going from the root towards leaves of the tree, and thus each node becomes more specific per the characterization and definition of the job. However, it may usually not be useful to reach depths of more than 3-4 hierarchical levels, since in these deeper levels the distinctions between professions become unclear, and the transitions between professions are rarely meaningful. Profession tree 110 may be based on data input by or collected from users of career path calculator application 123, or from publicly available data, which may be collected e.g., from the internet, e.g., from social networks, etc.

According to some embodiments, database 101 may further comprise a skills per profession database 111. Skills per profession database 111 may comprise a list of skills, and may include correlation or relationships between the listed skills to various professions, e.g., the professions stored in profession tree 110. In some embodiments, a person may use various skills in order to define his job, or define himself as an employee (e.g. personal traits, talents or abilities). Therefore, skills per profession database 111 provides correlation between various skills and various professions. For example, a skill, such as being able to program software using the JavaScript programming language, may be correlated to professions such as “software engineer”, “Web application designer” and “Software Support engineer”. However, a skill such as “quick learner” is a personal trait, which is not necessarily correlated to any specific profession.

In some embodiments, processing unit 102 may comprise, or may be operationally connected to a profession and/or skill classification engine 120, which may be configured to associate a profession, a management level, and an experience level with a job title, which may either be received from the user, or fetched from accessible resources, e.g., public domains, such as social networks. In some embodiments, profession classification engine 120 may be configured to associate a profession, a management level, and an experience level with a skill or set of skills, which may either be received from the user, or fetched from accessible resources, e.g., public domains, such as social networks. Since, in some cases, a job title and/or skill may be a narrow definition of the user's work position, whereas in other cases, a job title and/or skill may be too general, system 100 is designed to use a predetermined set of professions selected from profession tree 110. Therefore, profession classification engine 120 may receive a job title and/or skill(s) from the user (or from other accessible domains), and associate the job title and/or skill(s) with a profession from profession tree database 110.

Profession classification engine 120 may associate a job title with a management level, according to the number of employees that the user manages or supervises. In addition, profession classification engine 120 may associate the job title with an experience level, according to the number of years that the user has been working under the same job title. This processing of data inputted either by the user, e.g., a job title or position as defined by the user, or fetched from accessible resources, and further associating it with at least one of the following parameters: profession, management level, and experience level, may be referred to as normalization of the data received from the user. This data processing step or normalization of data is an important initial step required for future processing of data received from or fetched with respect to all users of application 123. In order to be able to compare between job titles which are provided in natural human language by users, rather than phrased using predetermined terms or rules, and in order to provide valid career statistics, all data received from user must be normalized to use a predetermined set of terms, in order to conform to the same set of parameters and to enable relevant comparison.

In some embodiments, processing unit 102 may comprise or may be operationally connected to transition probabilities statistical calculator 121. Transition probabilities statistical calculator 121 may be configured to perform statistical calculations regarding probability of transition from profession X, with management level Y and experience level Z, to profession A with management level B and experience level C. These statistical calculations may be based on data of recorded transitions performed by other users of application 123, or on data which includes recorded transitions performed by other people as may be determined based on publicly accessible data, which may be collected from various available resources, e.g. the internet and/or from social networks.

In some embodiments, processing unit 102 may further comprise or may be operationally connected to transition classification statistical calculator 122. Transition classification statistical calculator 122 may be configured to perform statistical calculations regarding classification of the transitions, e.g., regarding the type of job transition or type of profession transition. For example, a transition or change in a job position may be considered as a lateral transition, which means that the person or user may move to a different job, while remaining at approximately the same profession, and at approximately the same management level. In other cases, a change in a job position may be considered as a vertical transition, e.g. a promotion, which means that the person or user may move to a job that is associated with a higher management level, and/or which may or may not be of a slightly different profession. A vertical transition (job promotion) is a transition of a person to a new job that is considered a higher ranked position compared to the previous position the user held. In yet other cases, changing a job may be considered a change of profession or cross-function, which means that the person or user is switching to a different profession altogether.

Transition classification statistical calculator 122 may pre-classify various job positions as either a professional transition, i.e., transition from one workplace to a different workplace while maintaining the same profession (lateral transition), promotion (vertical transition) or change in profession (cross-function), with respect to a source profession. In some embodiments, transition classification statistical calculator 122 may record user preferences regarding job position transition types that are offered to the user, and which were pre-classified by transition classification statistical calculator 122. The user's preferences are then statistically analyzed in order to determine which of the transition type classifications a user is more open to accept and follow, thus career path calculator application 123 may later create a career path that is more suitable to the user, since the user is more likely to follow a career path that is calculated based on the user's preferences. For example, for a user who indicates he's looking for a promotion, only vertical transition positions may be suggested or included in the career path generated for the user. For users who indicated they are interested in changing profession, appropriate positions may be included in the career path display.

In some embodiments, and as mentioned hereinabove, processing unit 102 may comprise or may be operationally connected to a career path calculator application 123, which may be configured to calculate a personalized career path per a user, for example (but not necessarily) in real-time or substantially real-time. The career path may be calculated based on a combination of data in database 101, and on calculations performed by profession classification engine 120, transition probabilities statistical calculator 121, and transition classification statistical calculator 122. Application 123 may create a career path that is suitable for a specific user, following the user's former and current job positions, and based on probability of transitions performed by other users and/or other employees around the world. The career path may include at least a source profession (e.g., the current profession practiced by the user), a target profession (e.g. the “dream job” that the user wishes to achieve), and possibly (but not necessarily) transition professions which may be required to reach the target profession. For example, the professions may be represented as nodes in a directed graph, as shown e.g., in FIGS. 7A-7G, and the edges of the graph may indicate the transition probability score associated with the transition from one profession (node) to another. The directed graph is a set of vertices or nodes that are connected together, where all the edges are directed from one node to another.

The career path may allow a user several levels of path display, which will be further detailed with relation to FIGS. 7A-7G, which describe examples of multiple career paths. The career path may be displayed using a hierarchical tree structure, wherein the target profession may be a root value (first level), the transition professions may be subtrees of children with a parent node, represented as a set of linked nodes (one or more levels above the first level), and the source professions (upper most level) may be leaves also represented as a set of nodes linked to the nodes of the transition professions. In other embodiments, the career path tree may be displayed in an opposite order, such that the source profession is the root, e.g., the first level, and the target profession is the upper most level, e.g., the leaves of the tree, while the transition professions are levels in between the source profession and the target profession.

Application 123 may further take into consideration the user's preferences per what type of career transition the user is willing to follow, or what type of career transition the user wishes to follow. Furthermore, application 123 calculates a most probable or likely career path, and/or a shortest career path for the user to follow in order to reach his professional goal.

According to some embodiments, in order to provide information to a user regarding a probable or likely and/or shortest route for a user to reach his professional goal, i.e., in order to provide the user with his personalized career path, the career path may be visually displayed to the user. Thus, system 100 may comprise a display unit 103, which may display career path 130 to the user. Career path display 130 may comprise visual graphics and/or audio, in order to provide a clear and user-friendly display of the proposed career path. Various types of graphics may be used, which may include interactive buttons and icons. The career path display 130 may, in some cases, appear in its entirety in one mouse click, or one swipe of a finger, whereas in other cases, the career path display 130 may unfold in a gradual manner, whereby a user input such as a mouse click, or swipe of a finger reveals a set of new transition(s), which are part of the entire career path display 130, as will be explained in detail with respect to FIGS. 7A-G.

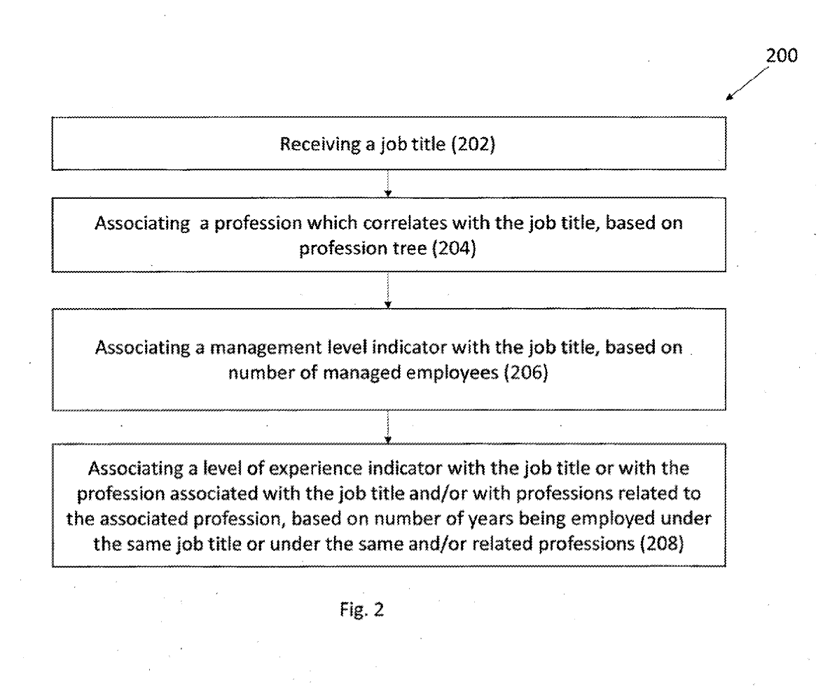

Reference is now made to FIG. 2, which is a flowchart of a method 200 for performing profession classification, according to exemplary embodiments of the disclosed subject matter.

In order to be able to compare between job positions or job titles as provided in natural human language by different users, which is a fundamental step of creating a reliable career path, there is a need to normalize job titles, which have endless variations (due to different organizations or companies providing different job title definitions), into one common baseline. Thus, method 200 may be performed for example, by profession classification engine 120, in order to correlate between job titles (typically inputted by the user) and a normalized job definition, which comprises at least one of the following parameters: profession, management level and experience level.

In operation 202, processing unit 102 may receive input of a job title, e.g. provided by a user of application 123. The job title may either be obtained from the user, or in other embodiments, once the user inserts his name, application 123 may automatically search publicly accessible domains and resources, such as social networks, in order to collect information, specifically job related information, in order to determine the user's job title.

In operation 204, the job title is associated with a profession, which highly correlates with the job title. The profession may be selected from the list of professions included in profession tree database 110. Association of the job title with the profession that best matches it, may be done according to several rules. The rules are assigned with a priority, such that if a job title fails to match with a profession via a rule which was assigned a high priority, a lower priority rule may be applied in order to find a match between the job title and a profession from profession tree database 110.

In some embodiments, one rule may be based on matching or comparison of word to word between a job title and a profession, while including the ability to replace abbreviations with the full matching word. For example, if a job title contains “Front end dev”, the profession that would be associated with it would be “Front end development”, since “dev” is an abbreviation of “development”. Other rules may be based on comparison of an entire title to a profession from the profession tree database 110, while searching for a common word.

A rule of lower priority may be based on identifying at least one word included in the job title, and comparing it to the profession tree database 110. For example, for a job title containing “Front end dev”, the profession that may be associated with it may be “Development”, which is of course, a less-specific profession classification compared to “Front end development”, and thus such rule is assigned a lower priority, however, it still enables to extract some information out of the obtained job title.

In operation 206, a management level indicator is associated with the job title. The management level may be based, for example, on the number of employees that the user is managing (or is in charge of), or on a range of numbers of employees that the user is supervising. In some embodiments, the user is required to provide such information, whereas in other embodiments, such information may be fetched from social networks, and the like. The value of management level may be calculated, for example, by assigning the number of employees that the user is in charge of as the management level value, for example, if the user does not supervise employees, then the associated management level value would be 0. If, for example, the user has ten employees under his supervision, then the appropriate management level value would be 10. In other embodiments, other numerical characterizations may be used in order to determine the management level value associated with a job title or position.

Finally, in operation 208, an experience level indicator is associated with the job title or with the profession associated with the job title, as in operation 204. In some embodiments, an experience level indicator may be associated with the profession associated with the job title as well as with professions related to the associated profession. The experience level may be based on, or correlated to, the number of years that the user has been employed under the same job title or under the same profession and/or related professions. For example, if a user is a Marketing Vice President, and has been working under this title for the past five years, then the experience level may be assigned the value 5. In other embodiments, the experience level may be calculated in a different manner, or include other numerical characterization in order to assign an experience level value to a job title. In yet other embodiments, the experience level may be defined as junior, medium or senior, wherein each of these three definitions is associated with a range of years of employment under the same job title or normalized job title, e.g. 0-3 years may be considered junior, 4-8 years may be considered medium, and above 9 years may be considered senior. In other embodiments, the experience level indicator may be associated with a profession (that is associated with the user's job title) and/or other related professions. For example, a lawyer may accrue experience as a litigator for three years, and then during an additional three years as a corporate lawyer, both related to the “lawyer” profession, thus, the experience level indicator may be assigned the value 6, which is the total number of years that the user is accumulating experience under the law profession.

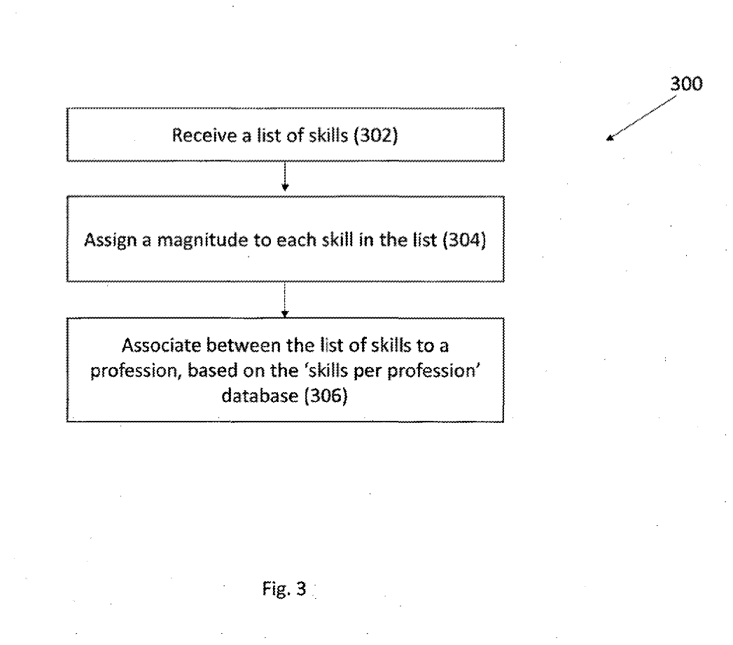

Reference is now made to FIG. 3, which is a flowchart of a method 300 for correlating between skills and professions, according to exemplary embodiments of the disclosed subject matter. Similarly to job titles comprising endless variations, and being assigned differently per each company, organization, or institute, skills also comprise endless variations and numerous definitions. Thus, there is a need to find correlation between skills and professions, in order to provide a normalized baseline of professions, which may be used for statistical calculations and comparison between users, towards creating a career path. In some embodiments, correlation between skills and professions, is performed independently of correlation between job titles and professions.

In operation 302, an application, e.g., application 123, may receive a list of skills, which corresponds to a specific user. The list of skills may be received from the user. However, in other embodiments, the list of skills may be automatically searched for by application 123 at public domains, following input by the user of a few initial personal details, e.g., name, age, current work place, etc. Public domains that application 123 may search through for further skill related information on the user, may be, for example, social networks, website of current work place, etc.

In operation 304, application 123 may assign a magnitude to each skill in the list. Since some skills may be general skills, which may be relevant to a large variety of professions, while other skills are quite specific per a specific profession, skills are assigned with a magnitude. General skills, such as being a good team-worker may receive a low magnitude, since it is a personal trait which is not specific enough and may be relevant to multiple professions. However, a more specific skill, such as being a fluent talker, may be relevant to professions that involve appearing in front of people, e.g., a salesperson or any other marketing related profession, a lecturer, an attorney, etc. Such a less general skill may receive a medium magnitude, since is it not specific per one profession, however, it is less general than the skill of being a team-worker. A yet more specific skill, such as litigation, may be assigned with a high score, since it is clearly specifically relevant to the law profession. Similar skill classification or magnitude assignments may be applied per any skill, in accordance with its specificity or lack of specificity to a certain profession.

In operation 306, application 123 may associate between the list of skills to a profession, based on profession tree database 110. Application 123 may associate between the set of skills to a profession via profession and/or skill classification engine 120. Profession and/or skill classification engine 120 may correlate between the entire list of skills to a specific profession, while taking into consideration the magnitude assigned to each of the listed skills. The combination between each of the listed skills and their magnitude (which further indicates on correlation to a general or specific profession) enables correlation between the listed skills and a specific profession. In some embodiments, the profession tree database 110 may comprise correlation between skills to professions, which is known based on information collected on other users of application 123. Based on information or data collected on an initial number of users, and thus based on predetermined correlation between these users' skills and their professions, as stored in profession tree database 110, correlation between other users' skills and their professions may be performed.

In some embodiments, application 123 may perform correlation between a job title and a profession independently of performing correlation between a list of skills and a profession. Therefore, application 123 may compare between the results of each of the methods illustrated in FIGS. 2 and 3, i.e., between the profession correlated to the job title and the profession correlated to the listed skills. In some embodiments, if one profession is a specification of the other, e.g., if one is a ‘software developer’ and the other is a ‘server software developer’, then application 123 may select the more specific profession among the two. In other embodiments, the less specific profession may be selected. In yet further embodiments, if the profession that was defined as per the job title is different from the profession that was defined as per the listed skills, an arbitrary choice between the two may be made. In some cases the profession may be selected to be the one based on the job title, whereas in other cases the profession may be selected according to the one based on the list of skills.

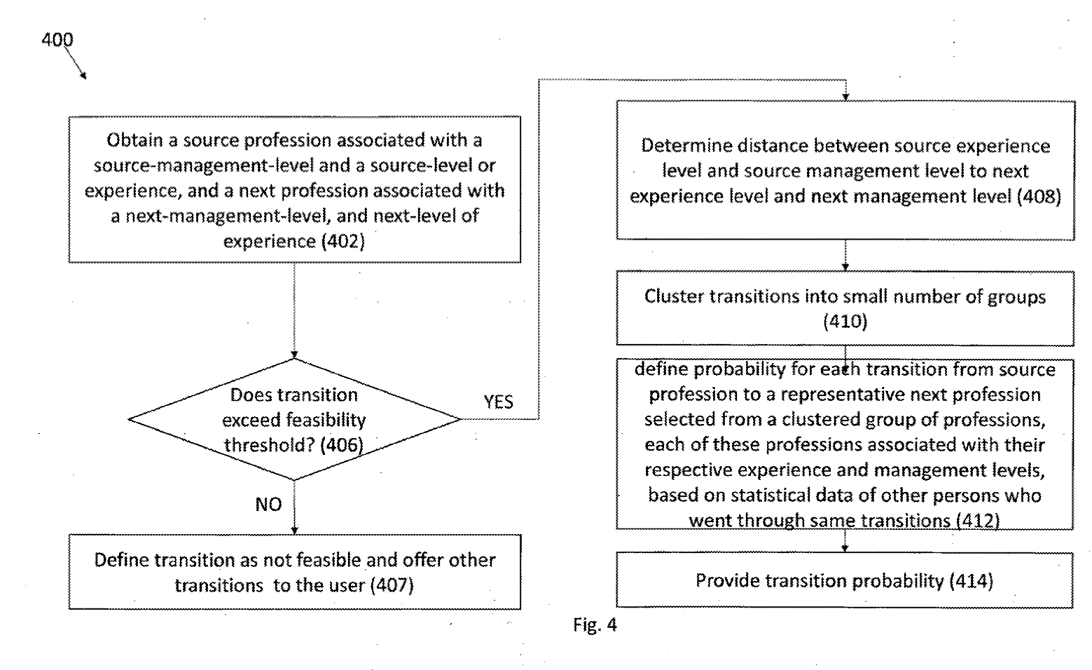

Reference is now made to FIG. 4, which is a flowchart of a method 400 for calculating probability of transition from one profession to another, according to exemplary embodiments of the disclosed subject matter. In order to create a career path, the basic required information is information related to probability of a transition from a first profession to a second profession. If probability of transition from a first profession to a second profession is high, the career path should include such a transition, since if the user wishes to reach the second profession, it is highly probable that he would reach it after holding the first profession. On the contrary, if probability of transition from a first profession to a second profession is low, then it is quite safe to determine that if the user wishes to reach the second profession, chances are low that he would reach it after holding the first profession. Thus, if probability of transition from one profession to another is low, such a transition should not be part of the user's personalized career path.

According to some embodiments, the next profession following the source profession may be defined as the target profession or as a transition profession, which may be a step towards reaching the target or goal profession. Similarly to the source profession, the next profession may be associated with a next-management level and a next-experience level.

In operation 402, a source profession and a target profession are defined by career path application 123. A source profession is typically the profession that the user is currently holding, though this is not a necessary requirement. A source profession is a profession that the user may begin with prior to switching to a target profession. That is, a target profession is the user's professional goal or one of his professional goals, which the user would like to get to. The user is in fact seeking for the fastest and most efficient way of reaching the target profession, for which purpose the career path is created. According to operation 402, the defined source profession is associated with a source-management level, and with a source-experience level. In addition, the defined target profession is associated with corresponding target-management level and with a target-experience level. In some embodiments, a single feasibility threshold is defined for transition between any source profession and any target profession. The feasibility threshold is a predetermined threshold that assists in defining which transitions are considered feasible and which are not. For example, if the source profession is a medical doctor, and the target profession is a guitar player, the probability of transition is lower than the feasibility threshold, since very few people ever went through such a career transition, and such a career transition is considered non-feasible. The feasibility threshold may be based on the number of transitions performed by other users. The number of transitions that is determined large enough in order for a transition to be considered feasible, may be pre-selected or pre-defined by application 123. The feasibility threshold applies to any transition and any transition may be compared to it in order to determine whether or not the transition is feasible.

In operation 406, it is determined whether or not the transition from the source profession, which is associated with source management level and source experience level, to the target profession which is associated with target management level and target experience level, exceed the feasibility threshold. If the transition between professions does not exceed the feasibility threshold, then in operation 407, the transition is defined as not feasible and other transitions may be offered to the user.

However, if the transition between professions is higher than the feasibility threshold, then in operation 408, a distance between the management level and experience level of the source and target professions may be calculated according to various methods. For example, in order to calculate distances between experience and management levels, these levels may be represented in numbers (e.g., experience level may be represented as the number of years the user is being employed under a certain profession or related professions, and management level may be represented as the number of employees managed or supervised by the user). Once the experience and management levels are associated with numbers, the distance between two pairs of experience and management levels may be calculated, e.g. as an Euclidean distance between points in a two-dimensional space, wherein each two-dimensional point represents a pair of levels (e.g., the X coordinate may be the numeric experience level and the Y coordinate may be the numeric management level). Therefore, two points in this space represent two pairs of experience and management levels. Considering all transitions between a specific pair of professions, e.g., ProfA and ProfB, all observed transitions from ProfA to ProfB (denoted ProfA->ProfB) may be clustered into a number of groups, as in operation 410. The clustering may be based on experience and management levels. K-Means or another clustering algorithms may be employed, yielding a small number of clusters of transitions (e.g., 2-4 clusters), where the experience and management levels of the transitions within each cluster are similar, and the experience and management levels between different clusters vary more widely. There may practically be infinite observed transitions between professions. For example, when denoting the transition from ProfA, with experience level Ea and management level Ma, to ProfB, with experience level Eb and management level Mb, as: ProfA(Ea,Ma)->ProfB(Eb,Mb), there may be, for example, the following transitions: ProfA(0,0)->ProfB(0,0); ProfA(0,0)->ProfB(0,1); ProfA(1,0)->ProfB(0,0), etc. Clustering all the observed transitions into a finite number of groups enables application 123 to consider a smaller number of transitions, which may be representatives of the entire range of possible transitions (e.g., all the transitions in each cluster are represented by a single representative from the cluster, ideally the ‘center’ of the cluster). Having reduced the range of possible transitions to a relatively small, finite group, application 123 may then perform a statistical analysis to determine the likelihood or probability of each (canonical, representative) transition to a clustered group of professions. Therefore, representatives of each of the clustered transitions are the only transitions referred to during the calculation.

In operation 412, the probability for each transition is defined, based on other persons who went through the same transition. Probability of transition is defined by the number of persons who started with the source profession associated with the specific source-management and experience levels, and moved on to the target profession associated with the specific target-management and experience levels. Thus, in operation 414, transition probability is provided per the specific source and target professions, associated with their respective management and experience levels. Transition probability may be provided in percentages as follows: “The probability of a person, whose career path up to this point includes profession A with experience level Ea, management level Ma, and profession B with experience level Eb, management level Mb, to becoming X_{target}, E_{target}, M_{target}, is P %”. For example, if a person or user currently holds a job of a salesperson, which he became following a job in customer support, the transition probability of that person becoming a product manager may be provided as follows: “the probability of person A whose career path includes customer support with experience level of 0.5, and management level of 0.7, and sales with experience level 0.9, and management level of 1, to becoming a product manager with experience level 0 and management level of 0.5, is 70%”. In some embodiments, the transition probability may be displayed to the person or user of career path calculator application 123. The transition probability may be displayed on a display unit, e.g., display unit 103 (in FIG. 1). The display of the transition probability information may include words and numbers, as well as graphical icons.

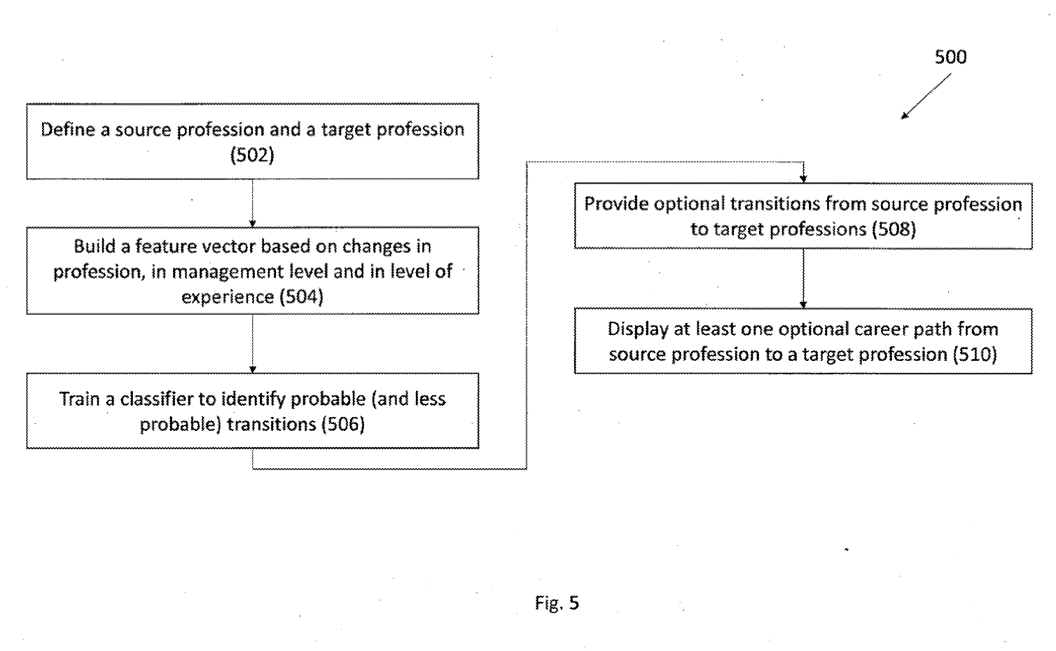

Reference is now made to FIG. 5, which is a flowchart of a method 500 for providing a career path to a user, according to exemplary embodiments of the disclosed subject matter. According to embodiments of the present invention, career path application 123 may provide a career path, which is personalized per a specific user, and which may illustrate to that user the best or preferable route through which he may get from a source profession to a target profession. In some embodiments, the source profession and the target profession may be both defined by the user, whereas in other embodiments, the source profession is typically the job that the user is currently holding, and the target profession may be suggested or offered to the user by application 123, and may be classified as either a professional transition (lateral transition), a promotion (vertical transition) or a change in profession (cross-function).

In operation 502, a source profession and a target profession are defined. Typically, these two professions are defined by the user, who wishes to receive his personalized career path, which will illustrate the path he should follow from the source profession in order to reach the target profession the user defined, in the shortest and most probable manner. The source profession should typically be associated with corresponding source-management level and source-experience level, while the target profession should typically be associated with corresponding target-management level and target-experience level.

In operation 504, application 123 may build a feature vector that includes values of parameters associated with statistical changes in profession, management level and in experience level. For example, the feature vector may include the fraction or percentage of persons that held the source profession and moved to the target profession. The feature vector may further include the percentage of persons that currently hold the target profession and arrived to it from the source profession, the average net addition in management level between the source profession and the target profession. In other embodiments, the feature vector may include the percentage of persons who held the source profession and were offered with the target profession, and who provided a positive response to the offer of transition from the source profession to the target profession. In yet other embodiments, the feature vector may include the percentage of persons that held the target profession and moved to the source profession, the percentage of persons who currently hold the source profession and arrived to it from the target profession. In yet further embodiments, the feature vector may include the percentage or persons who held the target profession and were offered with the source profession, and who provided a positive response to the offer of transition from the target profession to the source profession. In other embodiments, other features regarding changes in profession, management level and/or experience level may be included in the feature vector.

In operation 506, a classifier is trained to identify probable profession transitions. That is, the feature vector is used as part of a classifier to determine whether any possible profession, which may be defined as the target profession, and which may be reached from the source profession (which is typically defined by the job that the user currently holds), is classified as one of a lateral transition, a vertical transition, or a cross-function. The classifier is trained to identify probable profession transitions from a source profession to a target profession, and then, in operation 508, to provide optional transitions from the source profession to the target profession. According to some embodiments, providing optional transitions refer to providing classification as to what type of transition it is, e.g., whether it is a lateral transition, a vertical transition or a cross-function. According to some embodiments, each type or class of transition, as listed above, may yield a transition probability score. The transition classification assigned with the highest transition probability score defines the type of transition.

In some embodiments, once optional transitions from the source profession to the target profession are provided, at least one optional career path from the source profession to a target profession may be displayed to the user, as in operation 510. For example, when the type of transition with the highest transition probability score is identified, in real-time, a corresponding career path that includes such type of transition may be displayed to the user. In some embodiments, several optional career paths may be displayed to the user. A career path from the source profession to a target profession (which may be predefined by the user, or may be offered by application 123) may be displayed to the user, e.g., on display unit 103. The career path may be displayed in a graphical user-friendly visual and/or audio manner.

In some embodiments, the application may be configured to display not only the career path including the highest transition probability score, but rather additional career paths with lower transition probability scores. The number of optional career paths, along with their transition probability scores that may be displayed, may be predefined by the user prior to calculations of career path calculator application 123, while in other embodiments, the number of optional career paths displayed with their transition probability scores may be defined after calculations of career path calculator application 123.

According to some embodiments, a career path may typically include at least a minimal number of transitions, e.g. at least one transition, and at most a maximum number of transitions, e.g. not more than three transitions, since over three transitions may be too long to be useful to a user. However, other ranges of number of transitions included within a career path may be implemented. In some embodiments, a source profession associated with a source management level and a source experience level may be labeled as P(0). The few transition professions that are assigned with the highest transition probability score as the next professional step following the source profession, for example, transition professions assigned with the highest transition probability score as being reached from the source profession, may be labeled as P(1, 1), P(1, 2), P(1, 3), P(1, 4) and P(1,X), wherein X may be for example, five, e.g., five transition professions being the next step following the source profession. Similarly, the target profession may be labeled as P(N), and thus the transition professions assigned with the highest transition probability score as the professional step prior to the target profession, for example, transition professions assigned with the highest transition probability score as leading to the target profession, may be labeled as P(N−1, 1), P(N−1, 2), P(N−1, 3), P(N−1, 4) and P(N−1, Y), wherein Y may be for example, five, e.g., five transition professions leading to the target profession.

In some embodiments, the transition professions that are assigned with the highest transition probability score, and which are transition professions in between the source profession or any of the next professions (e.g., P(1,1)) and the target profession or any of the transition professions leading to the target profession (e.g., P(N−1, 2)) may be determined. For example, ten transition professions assigned with highest transition probability score as leading from the source profession to the target profession may be determined. Each of these determined transitions define a different career path starting from node P(0), optionally passing through node P(1, X), further optionally passing through node P(N−1,X) and ending at node P(N). In some embodiments, each of these career paths include at least one transition and at most three transitions from the source profession to the target profession. According to some embodiments, career paths that pass through a single profession more than once, should be excluded from consideration.

In some embodiments, a career path score may be assigned per an entire career path (and not only per each transition between the nodes/professions along the path). The career path score may be calculated based on the transition probability scores between the nodes (e.g., the transition professions) included in the career path. For example, the career path score may be calculated by multiplying the transition probability scores between all nodes of the career path, and dividing this multiplication by the natural algorithm of the sum of the number of years typically spent at each node (e.g., each transition profession). In some embodiments, the expected or typical number of years spent at each transition profession, may be calculated based on observed statistical data. An additional example of calculating the career path score may be by merely multiplying or summing the transition probability scores associated with each node included in the career path. Other methods of calculating the career path score may be implemented. The career path score may be used in order to prioritize the optional career paths determined by application 123. Accordingly, in some embodiments, the career path assigned with the highest path probability score may be the only career path displayed to the user. However, in other embodiments, more than one career path may be displayed to the user, preferably with its assigned career path score, while the order of display may be determined based on the associated path probability score, e.g. from highest career path score to the lowest career path score, or from the lowest career path score to the highest. The number of career paths to be displayed to the user along with their total career path score may be configurable by the user or predefined e.g. in application 123.

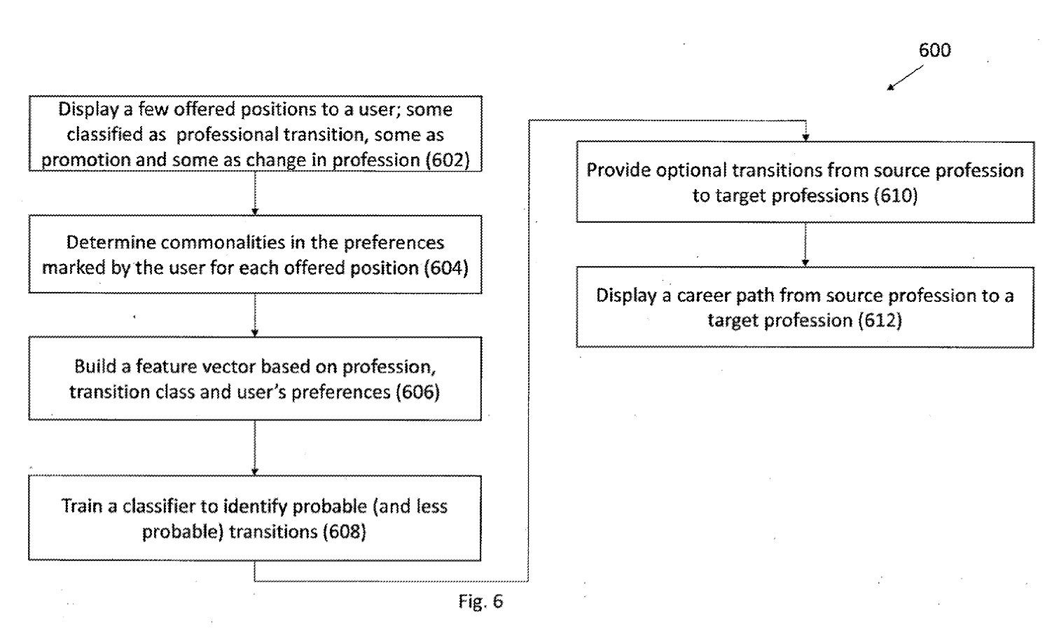

Reference is now made to FIG. 6, which is a flowchart of a method 600 for choosing a career path for a user, according to exemplary embodiments of the disclosed subject matter. In some embodiments, application 123 may suggest a career path that is adjusted per the user's preferences, which may be examined and defined by application 123 prior to calculating a career path to the user. According to some embodiments, operation 602, may comprise displaying a few offered job positions to a user; some pre-classified as lateral transition, some as vertical transition and some as cross-function. That is, application 123 may display a few optional positions to the user, in order to collect the user's feedback on each of these offered positions. Analyzing the likes and dislikes of the user per each of these proposed job positions and determining commonalities between the user's preferences marked by the user for each offered position, may be accomplished in operation 604. By determining commonalities between the user's preferences, application 123 in fact “learns” which job offers it may offer him later on, and which the user is most probable to pursue as a possible next career step. In some embodiments, each expressed opinion of the user regarding an offered job position may reveal the user's opinion about the offered profession, as well as the user's opinion about a transition from the job the user currently holds to the offered job position.

In operation 606, application 123 may build a feature vector that may be based on profession, class of transition (whether professional transition (lateral transition), promotion (vertical transition) or change in profession (cross-function)), and on user's opinion regarding the profession and transition. A classifier may then be trained in order to identify probable transitions, in operation 608. Linear regression may be performed, in real-time, in order to assign a score to any profession. Optional transitions may be provided by application 123, from the source profession to several target professions that conform to the user's preferences, as in operation 610. The target professions may be automatically selected by application 123 according to the user's preferences, which were used in order to enable machine learning by application 123.

The transitions may be classified by type of transition, e.g., to be classified as one of the following: lateral transition, vertical transition or cross-function. According to the user's preferences with regards to the offered professions, application 123 may also “learn” what type of transition the user is more probable to pursue. According to the scores assigned per each profession and transition probability, a career path may be chosen by application 123 and displayed to the user, in real-time, as in operation 612. A career path may be displayed from the source profession to one target profession or to more than one target professions, which are assigned with the highest or a high transition probability score. The display may be in a visual and/or audio manner including graphical elements, and may be displayed on a display unit, e.g., display unit 103. In other embodiments, instead of displaying a career path, application 123 may merely display a list of open positions offered to the user, which may be professions that the user may wish to pursue as part of his next career step. The list of offered positions may be selected according to the type of transition that the user is probable to pursue, which may be based on the user's preferences already “learned” by application 123.

Reference is now made to FIGS. 7A-7G, which are schematic illustrations of displayed career paths including a target profession and several transition professions and source professions through which and from which, respectively, the target profession may be reached, according to exemplary embodiments of the disclosed subject matter. FIG. 7A illustrates the professional goal of target profession that a user may wish to pursue. In the example illustrated in FIG. 7A, the target profession 700 is a CEO (Chief Executive Officer), though any other target profession may be selected per the user's preferences. Target profession 700 may be displayed to the user on a display unit, e.g., display unit 103. Target profession 700 may comprise various graphical interfaces in order to describe the target profession in a clear visual manner. In some embodiments, the display of each or a few of the steps along the career path may comprise auditory means.

In FIG. 7B, following a mouse click, a keyboard press, a tap of a finger, and so on, the career path may expand, and professions, e.g., source professions that may lead to the target profession 700, as well as the probabilities of reaching the target profession from each of these prior professions, may appear as part of the display. For example, the probability of transition from a position 702 of a CFO (Chief Finance Officer) to becoming target profession 700 of a CEO, is calculated as 6.3%, which is displayed on arrow 702a. Calculations of probability of a person or user to begin with one profession and then reach the target profession 700, may be calculated based on data collected on substantially all users of application 123, via, for example, Transition probabilities—statistical calculator 121 (in FIG. 1).

Similarly, other professions prior to the target profession may be displayed along with probability of transition from these transition professions to the target profession. In some embodiments, and as illustrated in FIGS. 7B-7G, probability of transition may be displayed as percentages on the arrows connecting between the transition professions to the target profession, which may be reached from these transition professions.

Additional examples of professions and corresponding transition probability for transition from such professions to the target profession, may comprise source profession 704 as CTO (Chief Technology Officer), and transition probability from source profession 704 (CTO) to target profession 700 (CEO), is illustrated next to arrow 704a, as 2.3%. Source profession 706 may be a marketing manager, and probability of transition from source profession 706 to target profession 700 (CEO) may be illustrated on arrow 706a, as 4.6%. Profession 708 may be a COO (Chief Operating Officer), and probability of transition from source profession 708 to target profession 700 (CEO) may be illustrated on arrow 708a, as 9.3%. Profession 710 may be sales, and probability of transition from source profession 710 (sales) to target profession 700 (CEO) may be illustrated on arrow 710a, as 4.8%. Source profession 712 may be an entrepreneur, and probability of transition from source profession 712 to target profession 700 (CEO) may be illustrated on arrow 712a, as 8.4%.

In other embodiments, additional and/or other professions, along with their corresponding transition probabilities may be displayed to the user. It should be clear that the professions currently defined as source professions may become transition professions, if and when new source professions leading to such current source professions are displayed.

FIG. 7C illustrates an additional career path related step that shows which professions prior to the ones illustrated in FIG. 7B a user may begin with, in order to reach the target profession 700. For example, when a user decides to press or click on any of the displayed professions, e.g., former source profession and currently transition profession 702 (CFO), a few new source professions that the user may begin with in order to reach transition profession 702, may appear and be displayed. For example, source profession 720 may be a finance controller, and probability of transition from source profession 720 to transition profession 702, may be 3.2%, and may be displayed on arrow 720a. Another example of a source profession from which a user may reach transition profession 702 (CFO) may be source profession 722, which may be a CPA (Certified Public Accountant), and probability of transition from source profession 722 to transition profession 702 may be 4.5%, which may be displayed on arrow 722a. Other and/or additional source professions that a user may follow in order to reach transition profession 702, on the user's path of pursuing the user's target profession 700, may be displayed to the user.

FIG. 7D illustrates a career path through which a user may pursue the target profession 700, which may be a parallel option to the career path illustrated in FIG. 7C. That is, FIG. 7D illustrates a different route a user may follow in order to reach target profession 700. For example, in order for a user to reach target profession 700, the user may first hold profession 706 (e.g., Marketing Manager). And in order for a user to hold profession 706, the user may first hold any of a few example source professions, e.g., Product Management, Account Management, and Marketing. In some embodiments, when a user presses, touches, or clicks on profession 706 (Marketing Manager), several source professions that the user may begin with prior to and for the purpose of reaching profession 706, may appear. For example, profession 760 may be product management, and probability of transition from source profession 760 to profession 706 may be 4.6%, and may be displayed on arrow 760a. Another example of a profession from which a user may reach profession 706 (Marketing Manager) may be source profession 762, which may be Account Management, and probability of transition from source profession 762 to profession 706 may be 4.9%, which may be displayed on arrow 762a. Yet another example of a profession from which a user may reach profession 706 (Marketing Manager) may be source profession 764, e.g., Marketing, and probability of transition from source profession 764 to profession 706 may be 7.7%, which may be displayed on arrow 764a. In some embodiments, the professions currently defined as source professions may become transition professions, if and when new source professions leading to such current source professions are displayed.

In some embodiments, inter-connections or inter-relationships between professions of different levels or between professions of the same level, may also be displayed, if and when relevant. For example, as illustrated in FIG. 7D, there may be an inter-connection between professions of the same level, both of which may lead to the target profession in one step. In this example, there may be an inter-connection between profession 710 (e.g., sales) to profession 706 (e.g., Marketing Manager), such that probability of transition from profession 710 to profession 706 may be 3.1%, which may be illustrated on arrow 716a.

FIG. 7E illustrates a yet further step in the career path, which may comprise professions a user may begin with prior to the professions illustrated in FIG. 7D, in order to pursue the target profession 700. Once a user clicks, touches, or presses profession 760 (Product Management), several professions a user may hold as preliminary professions prior to and for the purpose of reaching transition profession 760, may be displayed. For example, source/transition profession 770, which may be Project Management, and probability of transition from source/transition profession 770 to transition profession 760 may be 5.2%, and may be illustrated by arrow 770a. Another example of a profession from which a user may reach transition profession 760 (Product Management) may be source/transition profession 772, which may be Solution Management (presale), and probability of transition from profession 772 to transition profession 760 may be 7.1%, which may be displayed on arrow 772a. Yet another example of a profession from which a user may reach transition profession 760 (Product Management) may be source/transition profession 774, e.g., Software Development, and probability of transition from profession 774 to transition profession 760 may be 4.1%, which may be displayed on arrow 774a.

FIG. 7F illustrates additional preliminary steps in the career path, which may comprise professions a user may begin with prior to the professions illustrated in FIG. 7E, in order to pursue target profession 700. That is, once a user clicks, touches or presses any of the professions displayed as part of the career path, which is illustrated in FIGS. 7B-7G, corresponding source professions from which the user may start on his pursue towards the target profession, via transition professions, may be displayed. For example, in order to reach transition profession 772, which may be a Solution Management (presale), a user may start with source profession 780, which may be professional services, and probability of transition from source profession 780 to transition profession 772, may be 3.4%, illustrated by arrow 780a. Another way of reaching transition profession 772, may be through source profession 782, which may be, for example, engineering. Probability of transition from source profession 782 to transition profession 772 may be 3.6%, which may be illustrated by arrow 782a. Yet another example of a way to reach transition profession 772 may be from transition profession 774, which may in fact be an inter-connection between parallel professions, since from both transition profession 772 and transition profession 774 a user may reach profession 760 (Product Management) in one career step or jump. The transition probability of reaching transition profession 772 from transition profession 774 may be 0.95, which may be illustrated by arrow 784a.

Furthermore, in order for a user to reach transition profession 774 (Software Development), a user may begin with one of a few source-professions. For example, a user may begin with source profession 780, which may be Customer Support, prior to reaching profession 774. Probability of transition from source profession 780 to transition profession 774 may be 7.5%, which may be illustrated by arrow 780a. Another example of a source profession from which a user may reach profession 774 (Software Development) may be source profession 782, which may be Software Testing, and probability of transition from source profession 782 to transition profession 774 may be 17.0%, which may be displayed on arrow 782a. Yet another example of a source profession from which a user may reach transition profession 774 may be source profession 784, e.g., IT (Information Technology), and probability of transition from source profession 784 to transition profession 774 may be 11.9%, which may be displayed on arrow 784a. A user may also hold source profession 786, which may be DBA (Database Administrator), prior to and for the purpose of reaching transition profession 774, wherein transition probability from source profession 786 to transition profession 774 may be 23.5%, illustrated by arrow 786a. A user may further hold source profession 788, which may be Automation, prior to and for the purpose of reaching transition profession 774, wherein transition probability from source profession 788 to transition profession 774 may be 34.1%, illustrated by arrow 788a. Additional and/or other source professions may be displayed, as well as inter-connections between transition professions from any level to any level, if and when relevant.

Reference is now made to FIG. 7G, which illustrates another example of a career path a user may pursue in order to reach target profession 700. In the example illustrated in FIG. 7G, target profession 700 may be pursued via transition profession 710, further via source profession 770. However, a user may optionally pursue a different career path such to reach target profession 774 from transition/source profession 770. These are of course only examples of career paths that a user may pursue in order to reach his professional goal, e.g., target profession 700 or target profession 774. Many other combination of source professions, transition professions of several levels (e.g., professions 770, and 710) may be displayed to the user in a visual and/or auditory manner.

In other embodiments, the career path (illustrated by FIGS. 7A-7G) may be displayed in a reverse order, such that the first profession displayed to the user is a source profession, for example, the profession that the user currently holds, and by clicking, pressing or touching the source profession, various options for transition professions and finally various options for target professions may appear and be displayed to the user in a visual and/or auditory manner.

There is thus provided according to the present disclosure, a method for determining a career path, the method comprising the steps of: providing an application to a user for installation on a user's computerized apparatus or for remote access; receiving a current job title from the user; associating a source profession to said job title; associating a source management level to said job title; associating a source experience level to said job title; determining a target profession, along with target management and experience levels that chances of transition to it from said source profession along with source management and experience levels, exceed a feasibility threshold; calculating probability of transition from the source profession, to the target profession based on statistical data; classifying said transition as either a professional transition, a promotion or a change in profession; determining transition professions required to reach the target profession from the source profession; providing transition probability scores associated with the transition professions and the target profession, corresponding to probability of transition from the source profession to the transition profession, and from the transition profession to the target profession, based on statistical data; and generating, in real time, a display indicating a career path from a source profession, through transition professions to the target profession; and causing the application to display on a display unit, a career path including at least the source profession and the target profession.

In some embodiments, the method may comprise the step of defining a feasibility threshold above which transition from a source profession to a target profession is considered feasible. In some embodiments, the step of calculating probability of transition is based on database of other persons who went through the same transition. In some embodiments, the step of classifying the transition may comprise displaying several job positions for a user to provide his preferences per each job position, wherein each job position has a pre-classification selected from professional transition, promotion or change in profession, and determining commonalities between the user's preferences per the displayed job positions, in order to determine whether or not other job positions would be relevant. According to some embodiments, the step of associating a source profession to the job title is based on a profession database.

There is thus further provided according to the present disclosure a system for determining a career path, comprising: a processing unit configured to: provide an application to a user for installation on a user's computerized apparatus or for remote access; receive a current job title from the user; associate a source profession to said job title; associate a source management level to said job title; associate a source experience level to said job title; determine a target profession, along with target management and experience levels that chances of transition to it from said source profession along with source management and experience levels, exceed a feasibility threshold; calculate probability of transition from the source profession, to the target profession based on statistical data; classify said transition as either a professional transition, a promotion or a change in profession; determine transition professions required to reach the target profession from the source profession; provide transition probability scores associated with the transition professions and the target profession, corresponding to probability of transition from the source profession to the transition profession, and from the transition profession to the target profession, based on statistical data, and generate, in real-time, a display indicating a career path from a source profession, through transition professions to the target profession; and a display unit to provide a display indicating a career path including at least the source profession and the target profession. In some embodiments, the display is provided to the user in a visual and/or auditory manner.

In the context of some embodiments of the present disclosure, by way of example and without limiting, a term such as ‘operating’ implies also capabilities, such as ‘operable’.

Conjugated terms such as, by way of example, ‘a thing property’ implies a property of the thing, unless otherwise clearly evident from the context thereof.

The terms ‘processor’ or ‘processing unit’, or system thereof, are used herein as ordinary context of the art, such as a general purpose processor or a micro-processor, RISC processor, or DSP, possibly comprising additional elements such as memory or communication ports. Optionally or additionally, the terms ‘processor’ or ‘processing unit’ or derivatives thereof denote an apparatus that is capable of carrying out a provided or an incorporated program and/or is capable of controlling and/or accessing data storage apparatus and/or other apparatus such as input and output ports. The terms ‘processor’ or ‘processing unit’ denote also a plurality of processors connected, and/or linked and/or otherwise communicating, possibly sharing one or more other resources such as a memory.

The term ‘configuring’ for an objective, or a variation thereof, implies using at least a software and/or electronic circuit and/or auxiliary apparatus designed and/or implemented and/or operable or operative to achieve the objective.

A device storing and/or comprising an application and/or data constitutes an article of manufacture. Unless otherwise specified, the program and/or data are stored in or on a non-transitory medium.

The flowchart and block diagrams illustrate architecture, functionality or an operation of possible implementations of systems, methods and computer program products according to various embodiments of the present disclosed subject matter. In this regard, each block in the flowchart or block diagrams may represent a module, segment, or portion of program code, which comprises one or more executable instructions for implementing the specified logical function(s). It should also be noted that, in some alternative implementations, illustrated or described operations may occur in a different order or in combination or as concurrent operations instead of sequential operations to achieve the same or equivalent effect.

The corresponding structures, materials, acts, and equivalents of all means or step plus function elements in the claims below are intended to include any structure, material, or act for performing the function in combination with other claimed elements as specifically claimed. As used herein, the singular forms “a”, “an” and “the” are intended to include the plural forms as well, unless the context clearly indicates otherwise. It will be further understood that the terms “comprises” and/or “comprising” and/or “having” when used in this specification, specify the presence of stated features, integers, steps, operations, elements, and/or components, but do not preclude the presence or addition of one or more other features, integers, steps, operations, elements, components, and/or groups thereof.

The terminology used herein should not be understood as limiting, unless otherwise specified, and is for the purpose of describing particular embodiments only and is not intended to be limiting of the disclosed subject matter. While certain embodiments of the disclosed subject matter have been illustrated and described, it will be clear that the disclosure is not limited to the embodiments described herein. Numerous modifications, changes, variations, substitutions and equivalents are not precluded.

1. A method for determining a career path, the method comprising the steps of:
(a) providing user interface displayed on a user's computerized apparatus;
(b) receiving a current job title from the user;
(c) associating a source profession, a management level and an experience level to said job title;
(d) obtaining a target profession associated with a target management level and a target experience level;
(e) determining at least one career path comprising one or more transition professions required to reach the target profession from the source profession, wherein each transition profession is a profession that enables the user to progress towards the target profession;
(f) calculating transition probability scores associated with a transition of the user from the source profession to a transition profession of the one or more transition professions, or from a transition profession to a transition profession, or from a transition profession to the target profession, based on statistical career data;
(g) determining feasibility of each transition; and
(h) causing the user interface to display on a display unit, in real-time, a career path including at least the source profession and the target profession and the associated transition probability score per transition.

2. The method according to claim 1, wherein said calculating probability of transition is based on a statistical database storing data of other persons who went through the same transition.

3. The method according to claim 1, comprising classifying said transition as either a professional transition, a promotion or a change in profession.

4. The method according to claim 3, wherein said classifying said transition comprises: displaying several job positions to a user; receiving user input regarding preferences per each displayed job position, wherein each job position is previously classified as a professional transition, promotion or a change in profession; determining a user's transition classification preference based on the user's input; and suggesting new job positions to the user based on the user's transition classification preference.

5. The method according to claim 1, wherein associating a source profession to said job title is based on a profession database.

6. The method according to claim 1, wherein determining feasibility of the transition comprises comparing the transition probability score to a feasibility threshold.

7. The method according to claim 1, comprising defining a feature vector that includes values of parameters associated with statistical changes in profession, management level and in experience level; and training a classifier to identify probable profession transitions.

8. The method according to claim 1, comprising determining a plurality of optional career paths, and displaying the career paths with their associated transition probability scores.

9. A system for determining a career path comprising:
a processing unit configured to:
(a) provide user interface displayed on a user's computerized apparatus;
(b) receive a current job title from the user;
(c) associate a source profession, a management level and an experience level to said job title;
(d) obtain a target profession associated with a target management level and a target experience level;
(e) determine at least one career path comprising one or more transition professions required to reach the target profession from the source profession, wherein each transition profession is a profession that enables the user to progress towards the target profession;
(f) calculate transition probability scores associated with a transition of the user from the source profession to a transition profession of the one or more transition professions, or from a transition profession to a transition profession, or from a transition profession to the target profession, based on statistical career data;
(g) determine feasibility of each transition; and
(h) generate, in real time, a display indicating the career path from the source profession to the target profession; and
a display unit to provide the display indicating a career path including at least the source profession and the target profession and the associated transition probability score per transition.

10. The system according to claim 9, wherein said display is provided to the user in a visual and/or auditory manner.

11. The system according to claim 9, wherein said career path is displayed using a hierarchical tree structure.
